(19) United States
(12) Patent Application Publication
(10) Pub. No.: US 2022/0061338 A1
(43) Pub. Date: Mar. 3, 2022

(54) FOOD CASING

(71) Applicant: World Pac International AG, Balzers (LI)

(72) Inventor: Ekkehardt Th. F. SCHÄFER, Karlsruhe (DE)

(73) Assignee: World Pac International AG, Balzers (LI)

(21) Appl. No.: 17/463,705

(22) Filed: Sep. 1, 2021

(30) Foreign Application Priority Data
Sep. 1, 2020 (DE) 102020122855.4

(51) Int. Cl. A22C 13/00; B32B 5/02; B32B 27/36; B32B 27/12; B32B 7/12; B32B 1/08

(52) U.S. Cl. CPC A22C 13/0013; B32B 5/022; B32B 27/36; B32B 27/12; B32B 7/12; B32B 1/08; A22C 2013/004; B32B 2307/7246; B32B 2307/7244; B32B 2260/021; B32B 2597/00; B32B 2307/4026; B32B 2307/518; B32B 2262/062

(57) ABSTRACT

A food barrier-casing for foods which, in the casing, are scalded, cooked or heated in another manner, in particular for cooked-meat or scalded-emulsion sausages, ham, cured products, fish or processed cheese. The casing includes at least one water-vapour- and/or gas-impermeable film (1), and has an absorbent internal layer (2) made of individual fibers or made of a woven fabric, knitted fabric, or a nonwoven, bonded thereto and this internal layer (2) is impregnated with dyes and/or flavourings. The external side of the barrier-casing is predominantly formed of a polyester film (1a) made of polyethylene terephthalate and this polyester film (1a) is bonded via a bonding layer (1b) to the absorbent internal layer (2).

### INCORPORATION BY REFERENCE

The following documents are incorporated herein by reference as if fully set forth: German Patent Application No. 10 2020 122 855.4, filed Sep. 1, 2020.

### TECHNICAL FIELD

The invention relates to a food barrier-casing for foods which, in the casing, are scalded, cooked or heated in another manner, in particular for cooked-meat or scalded-emulsion sausages, ham, cured products, fish or processed cheese, where the casing is composed of at least one water-vapour- and/or gas-impermeable film which bears, bonded thereto, an absorbent internal layer made of individual fibers or made of a woven fabric or knitted fabric, preferably made of a nonwoven, wherein this internal layer has been impregnated with dyes and/or flavourings.

### BACKGROUND

A barrier-casing of this type is known from EP 0 992 194 B1. It has been commercially available for many years in the design according to FIG. 1 of EP 0 992 194 B1, where the absorbent internal layer is surrounded by a polyethylene layer, a polyamide intermediate layer and a polyethylene external layer.

Studies carried out by the Applicant can now reveal that this barrier-casing can suffer local damage under harsh operating conditions, in particular if it comes into contact with sharp-edged objects. A possible result of the local damage is that the casing fractures during the cooking procedure, when the emulsion therein, or the like, expands. This fracturing is a surprising occurrence, because the casing per se has high stability by virtue of its multilayer structure.

### SUMMARY

The present invention is now based on the object of improving a barrier-casing of the type described in the introduction in respect of its stability, in particular of preventing a local fracture.

This object is achieved according to the invention in that the external side of the barrier-casing is composed of a film with at least 50%, preferably at least 70%, in particular at least 80%, of polyester in the form of polyethylene terephthalate, and this polyester film has been bonded via a bonding layer to the absorbent internal layer.

Surprisingly, it has been found that the replacement of the polyamide film, and of the two polyethylene films surrounding the same, by a film composed at least predominantly of polyethylene terephthalate reliably prevents fracture of the barrier-casing under harsh operating conditions, even when the food therein is heated and expands greatly.

It is not insignificant that the omission of the polyamide film and of one of the two polyethylene films can provide considerable cost advantages.

Although DE 102 44 088 A1 has already disclosed a packaging casing with similar transfer properties, the flavourings intended for transfer in that case however are accommodated in a pulverulent filler, which in turn is embedded in a polymer matrix of the internal layer. That document provides no information concerning a directly absorbent internal layer which comprises no pulverulent filler and instead is made of individual fibers or of a woven fabric or knitted fabric or nonwoven.

Furthermore, EP 0 986 957 A1 discloses a similar packaging casing with flavourings in the internal layer. In that case, the flavourings are retained on the internal layer by a binder made of polysaccharide or protein. The same binder also serves for the bonding of the internal layer to a polyester external layer. There is no information concerning omission of the binder in the internal layer and instead concerning use of an absorbent internal layer.

For the sake of simplicity, the term “polyester film” is used in the present application for the film which is composed at least predominantly of polyester and which is used according to the invention, irrespective of the proportion of polyester therein.

It is preferable here that oriented polyethylene terephthalate, in particular biaxially oriented polyethylene terephthalate, is used as polyester.

The thickness of the polyester film is advantageously about 10 micrometres to about 60 micrometres, preferably about 15 micrometres to about 40 micrometres. Surprisingly, it has been found that this low wall thickness is sufficient to provide satisfactory resistance to fracture to the barrier-casing, even under harsh operating conditions. Even when the casing is subjected to controlled impact or perforation, there is no need for any concern relating to propagation of fractures from the perforations. The above controlled impact/perforation is advantageous in the case of certain products for bringing about a controlled loss of weight from the food therein.

The person skilled in the art has various available possibilities for the bonding of the absorbent internal layer to the polyester film. Firstly, it is possible to select a bonding layer made of adhesive, in particular silicone rubber, or of two-component epoxy resin. Secondly, the bonding layer can be composed of a polyethylene layer.

The latter alternative has proved particularly successful in experiments. In this case, the polyethylene layer is advantageously extruded in wet/paste form onto the polyester layer, so that it functions as adhesive for the absorbent internal layer that is then directly to be applied.

The absorbent internal layer is composed of cotton fibers, cellulose fibers, in particular regenerated cellulose fibers, viscose fibers or a mixture thereof, as is known per se.

The scope of the invention here includes the additional presence of polyethylene fibers distributed within the internal layer in order to assist the adhesive bonding of the absorbent internal layer to the polyethylene intermediate layer.

After the application of the absorbent internal layer by lamination, the packaging casing generally takes the form of a flat film, which is then shaped to give a flexible tube. The edges here, running in the longitudinal direction of the flexible tube, can be bonded to one another along a narrow overlap zone by adhesive bonding or welding.

Alternatively, the edges can lie alongside one another, without overlap, and can be bonded on the external side of the polyester film by a tape which runs in the longitudinal direction of the flexible tube and which overlaps the edges. The abovementioned tape which bonds the edges lying alongside one another on the external side of the polyester film is preferably composed of silicone rubber or of polyethylene. It can be bonded by heat-sealing to the polyester layer.

### BRIEF DESCRIPTION OF THE DRAWINGS

Further features and advantages of the invention are provided by the description below of a performance example with reference to the drawing, where:

FIG. 1 shows a cross section through the casing material and

FIG. 2 shows a cross section at the location of the joint.

### DETAILED DESCRIPTION

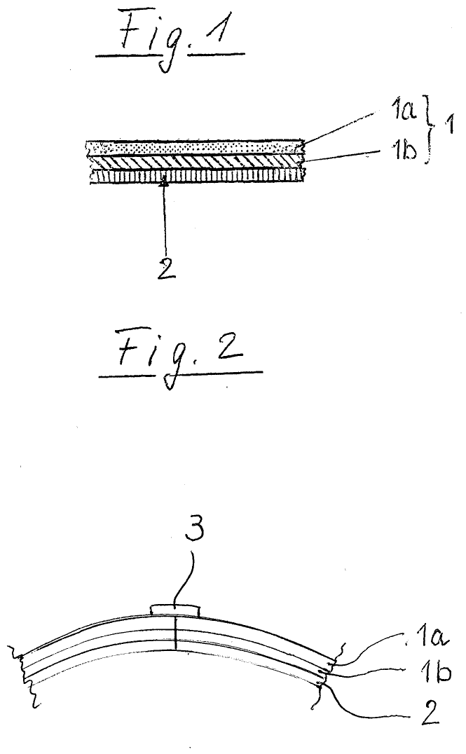

According to FIG. 1, the packaging casing comprises, externally, a film 1 and, internally, an absorbent internal layer 2.

The film 1 is composed of an exterior polyester layer 1a made of biaxially oriented polyethylene terephthalate and of a polyethylene layer 1b functioning as bonding layer in relation to the internal layer 2. The two layers 1a and 1b are responsible for protecting the food therein, and the flavourings or dyes of the absorbent internal layer, in particular from water vapour and oxygen, in order that the said food is not subject to leaching during the cooking or scalding process, i.e. does not loose flavour or colour. They moreover reliably prevent loss of weight during the manufacturing process, during storage or during transport.

The absorbent internal layer 2, for example a nonwoven made of cellulose fibers, serves as carrier for the desired dyes and/or flavourings. These can be caramel, spice extracts, smoke components, liquid smoke, marinades, fruit flavourings and other substances approved under food legislation. They can be applied continuously to the absorbent internal layer 2, either via a spray pipe along which the packaging casing shaped to give the flexible tube is passed or via a liquid bath into which the internal layer is immersed, or by means of a liquid bladder through which the casing is passed.

However, it is also possible instead that the internal layer 2, in particular in flat form, is printed with the desired dyes and/or flavourings.

After drying, the packaging casing is converted to flexible tubular shape and bonded by weldable, heat-resistant adhesive tape, or via thermal welding, to the abutted longitudinal edges.

The impregnated packaging casing can be used and processed either while moist or after drying.

All of the above layers of material 1a, 1b and 2 have been laminated to give a sheet. Its thickness is mostly below 1/10 mm, preferably between about 70 micrometres and about 90 micrometres. The thickness of the polyester layer 1a is about 20 micrometres, as also is the thickness of the intermediate layer 1b made of polyethylene.

The polyethylene layer 1b is advantageously extruded wet onto the polyester layer 1a, so that it functions as adhesive for the absorbent internal layer 2 which is then applied.

For the internal layer 2, it is advisable that the weight-per-unit-area applied of the absorbent material, i.e. the nonwoven, the fibers or the like, is 10 to about 50 g/m². This absorbent layer is then impregnated with the desired flavourings or colourants, and optionally shaped and dimensioned as required by the customer.

The packaging casing is mostly delivered in the shape of a flexible tube. The longitudinal edges of the casing here, located alongside one another without overlap, are bonded to one another by an adhesive tape 3 which covers both longitudinal edges, as shown in FIG. 2.

The adhesive tape 3 is composed of silicone rubber or polyethylene. It has a width of a few millimetres.

After the introduction of the food into the flexible tubular packaging casing, conventional methods are then used for closure at the sausage ends and separation of the individual sausages.

In summary, the packaging casing according to the invention is distinctive in using a small number of layers to achieve a good barrier property with high resistance to fracture.

1. A food barrier-casing for foods which, in the casing, are scalded, cooked or heated in another manner, the barrier-casing comprising:
at least one of a water-vapour- or gas-impermeable film (1),
an absorbent internal layer (2) made of individual fibers or made of a woven fabric, knitted fabric, or a nonwoven, said internal layer (2) being impregnated with at least one of dyes or flavourings, the absorbent internal layer being bonded to the at least one of a water-vapour- or gas-impermeable film (1),
an external side of the at least one of a water-vapour- or gas-impermeable film (1) comprises a polyester film (1a) with at least 50% polyethylene terephthalate, and
said polyester film (1a) is bonded via a bonding layer (1b) to the absorbent internal layer (2).

2. The barrier-casing according to claim 1, wherein the polyester film is a biaxially oriented polyethylene terephthalate.

3. The barrier-casing according to claim 1, wherein a thickness of the polyester film is about 10 micrometres to about 60 micrometres.

4. The barrier-casing according to claim 1, wherein the bonding layer (1b) comprises a silicone rubber or two-component epoxy-resin adhesive.

5. The barrier-casing according to claim 1, wherein the bonding layer (1b) is comprised of a polyethylene layer.

6. The barrier-casing according to claim 5, wherein the polyethylene layer (1b) is bonded by extrusion to the polyester film (1a).

7. The barrier-casing according to claim 5, wherein the absorbent internal layer (2) is bonded by lamination to the polyethylene layer (1b).

8. The barrier-casing according to claim 1, wherein the internal layer (2) is comprised of cotton fibers, cellulose fibers, viscose fibers, or a mixture thereof.

9. The barrier-casing according to claim 1, further comprising polyethylene fibers distributed within the internal layer (2), and said polyethylene fibers are bonded to the bonding layer (1b).

10. The barrier-casing according to claim 1, wherein the barrier-casing comprises a flat film shaped into a flexible tube, and film edges running in a longitudinal direction of the flexible tube overlap one another and are bonded on the external side of the polyester film (1a) by a tape (3) which runs in the longitudinal direction of the flexible tube and which overlaps the edges.

11. The barrier-casing according to claim 10, wherein the tape (3) is comprised of silicone rubber or polyethylene.

12. The barrier-casing according to claim 10, wherein the tape (3) is bonded by heat-sealing to the polyester film (1a).

13. The barrier-casing according to claim 1, wherein the barrier-casing is for cooked-meat or scalded-emulsion sausages, ham, cured products, fish or processed cheese.

14. The barrier-casing according to claim 1, wherein polyester film (1a) has at least 70% polyethylene terephthalate.
